(19) United States
(12) Patent Application Publication
(10) Pub. No.: US 2026/0246839 A1
(43) Pub. Date: Aug. 20, 2026

(54) MULTI-USER DISTRIBUTION OF USER PROFILES AND SETTING

(71) Applicant: A-DEC, INC., Newberg, OR (US)

(72) Inventors: Joseph David GILLIS, Newberg, OR (US); Spenser Matthew BRAY, Newberg, OR (US); Brent Haven DANIELS-SOLES, Stanley, NC (US); Steven Anthony QUINN, Newberg, OR (US); Ryan Douglas BECKHAM, Newberg, OR (US); Spencer Thomas WARNEKE, Brush Prairie, WA (US); Lee David HILLS, Sherwood, OR (US); Geoffrey Schuyler GOODMAN, Tualatin, OR (US); Ryan Michael WILLIAMS, Sherwood, OR (US)

(21) Appl. No.: 19/540,477

(22) Filed: Feb. 13, 2026

Related U.S. Application Data
(60) Provisional application No. 63/759,980, filed on Feb. 18, 2025.

(51) Int. Cl. H04L 67/12; H04L 9/40; H04L 67/1095

(52) U.S. Cl. CPC H04L 67/12; H04L 63/08; H04L 67/1095

(57) ABSTRACT

Embodiments herein relates to a system for communicating user profile data among different operatories of a dental office and among different dental offices, where the user profile data indicates preference for configuration settings of equipment such as a delivery system, a patient chair, a handpiece or an operatory light. The solutions allow users, e.g., dentists or other clinicians, to move between different operatories and dental offices while their preferences are automatically implemented without the need to re-enter the preferences.

### CROSS-REFERENCE TO RELATED APPLICATIONS

This application claims the benefit of U.S. provisional patent application No. 63/759,980, filed Feb. 18, 2025, entitled “Multi-User Distribution Of User Profiles And Settings,” and incorporated herein by reference.

### TECHNICAL FIELD

Embodiments herein relate to methods and apparatuses for controlling equipment in a dental office based on user profiles.

### BACKGROUND

Dental offices include various types of equipment such as chairs, tools, furniture and lighting which can be adjusted to optimize the comfort and efficiency of the dentist, hygienist or other user. In some cases, the adjustment is facilitated by the use of electric motors and a control panel. However, various challenges are presented in that frequent adjustments are often needed when different users use the same equipment, or when a given user uses different equipment.

### BRIEF DESCRIPTION OF THE DRAWINGS

Embodiments will be readily understood by the following detailed description in conjunction with the accompanying drawings and the appended claims. Embodiments are illustrated by way of example and not by way of limitation in the figures of the accompanying drawings.

FIG. 1A depicts an example system 100 for sharing user profile data within a dental office and between dental offices, in accordance with various embodiments.

FIG. 1B depicts an example computing device 195, in accordance with various embodiments.

FIG. 2 depicts an example implementation of the user interface (UI) device 124 of FIG. 1A, in accordance with various embodiments.

FIG. 3 depicts an example implementation of a system 300 consistent with FIGS. 1A, 1B, and 2, in accordance with various embodiments.

### DETAILED DESCRIPTION OF DISCLOSED EMBODIMENTS

In the following detailed description, reference is made to the accompanying drawings which form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense, and the scope of embodiments is defined by the appended claims and their equivalents.

Various operations may be described as multiple discrete operations in turn, in a manner that may be helpful in understanding embodiments; however, the order of description should not be construed to imply that these operations are order dependent.

The description may use perspective-based descriptions such as up/down, back/front, and top/bottom. Such descriptions are merely used to facilitate the discussion and are not intended to restrict the application of disclosed embodiments.

The terms “coupled” and “connected,” along with their derivatives, may be used. It should be understood that these terms are not intended as synonyms for each other. Rather, in particular embodiments, “connected” may be used to indicate that two or more elements are in direct physical contact with each other. “Coupled” may mean that two or more elements are in direct physical contact. However, “coupled” may also mean that two or more elements are not in direct contact with each other, but yet still cooperate or interact with each other.

For the purposes of the description, a phrase in the form “A/B” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the terms “embodiment” or “embodiments,” which may each refer to one or more of the same or different embodiments. Furthermore, the terms “comprising,” “including,” “having,” and the like, as used with respect to embodiments, are synonymous, and are generally intended as “open” terms (e.g., the term “including” should be interpreted as “including but not limited to,” the term “having” should be interpreted as “having at least,” the term “includes” should be interpreted as “includes but is not limited to,” etc.).

With respect to the use of any plural and/or singular terms herein, those having skill in the art can translate from the plural to the singular and/or from the singular to the plural as is appropriate to the context and/or application. The various singular/plural permutations may be expressly set forth herein for sake of clarity.

As mentioned at the outset, various challenges are presented in adjusting equipment in a dental practice or other medical practice.

Typically, when a user such as a dentist or other clinician moves between different operatories of a dental office or between different dental offices in different geographic locations, it is necessary for the user to adjust the equipment according to their preferences. However this can involve a number of manual and/or programming inputs which consume time and may result in less than optimal configurations that need to be adjusted again in an iterative process. Moreover, a user may encounter different models of equipment that require different configuration settings and have different capabilities. If the users do not spend the time to become familiar with the setup process, they may end up working with undesirable configurations.

One approach is for a user to log into a user interface (UI) of a piece of equipment, where there may be previously-stored settings for the user for that piece of equipment based on the user's previous use of the equipment. For example, the user could log in via a keypad by entering credentials (e.g., a user id and a password), facial recognition, scanning a badge, or using near-field communications. However, these approaches involve the users registering their preferences in each different piece of equipment each time the equipment is used. Difficulties arise in that a user may not be aware of the arrangement of equipment in a clinic or in a group of unrelated clinics. Also, user settings may be inadvertently changed or may be hard to activate via credential entry or badge scanning.

The solutions herein address the above and other issues. In one aspect, the solutions provide portable user profiles that are aware of the equipment the users are working with, to automatically configure the equipment according to the users'preferences. The profiles can be portable within a dental clinic or across different dental clinics. This is particularly advantageous for travelling clinicians. The profiles can improve efficiency by minimizing time spent on configuring the equipment and thereby allow the clinicians to focus on their patients.

In an example implementation, a user profile is activated and associated with equipment settings. An intelligent equipment settings program is aware of the equipment configuration and intelligently updates user level settings to learn the user profile preferences. This enables each clinical device in the system to behave exactly as the user expects, regardless of delivery system configuration.

User profiles can be quickly activated on an equipment menu without the need for credentials or badge scanning. Profile settings can be stored and locked in an application at any time to prevent unwanted changes, and are secured through the application credentials. This means credentials only need to be entered to lock/unlock settings editing, and not at the time of each use. As mentioned, this allows the users to focus more on their work.

User profiles and their associated intelligent equipment settings create a new level of consistency and efficiency through awareness of the business structure of the dental clinic and allow users to be permissioned into multiple, unrelated clinics.

The above and other features can be understood further in view of the following discussion.

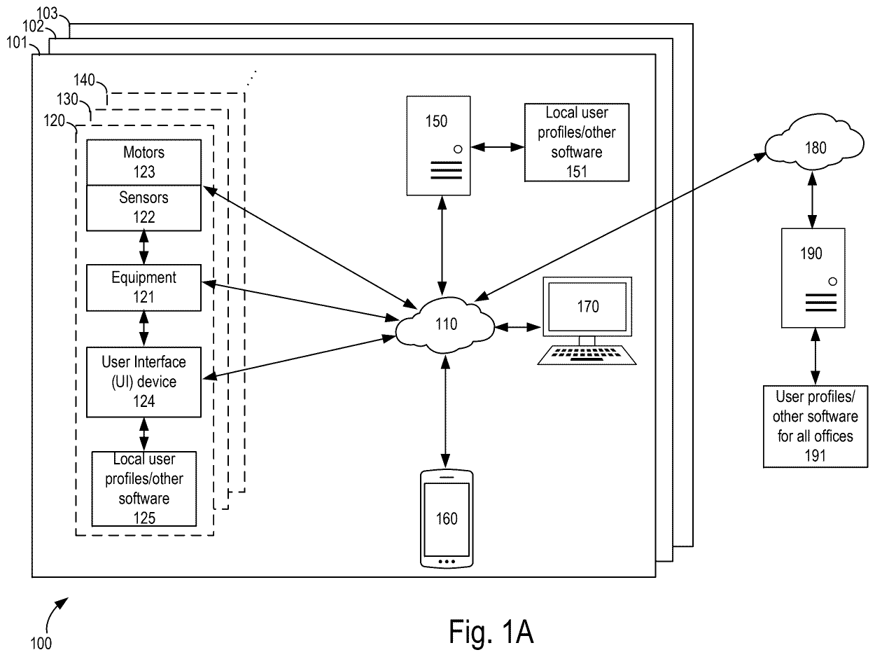

FIG. 1A depicts an example system 100 for sharing user profile data within a dental office and between dental offices, in accordance with various embodiments. The system includes multiple dental offices 101, 102 and 103 in different geographic areas. Each office has a similar configuration in this example but, generally, different offices can have differences in terms of the number of operatories and types of equipment. Details of the office 101 are provided as an example.

The office 101 includes a network cloud 110 that represents a local-area network. A network cloud 180 can represent a wide-area network such as the Internet that is in communication with the network within each office. In this example, a dental office 101 has multiple operatories 120, 130, and 140, typically separate rooms or partitioned areas where patients are served. The dental office can also include a front desk/reception area where patients are checked in, a business office area for an administrator who performs billing and other administrative tasks, a private office area for a dentist, a sterilization room, and a break room.

Each operatory can include equipment 121 such as delivery systems, patient chairs, other furniture such as tables, handpiece systems, operatory lights, and a control center, typically housed in a cabinet. An operatory can further include sensors 122 and motors 123 as part of the equipment and/or separate. For example, a chair can include sensors which detect the angles of the seat, backrest, arm rests and headrest, along with the height of the chair and the footrest elevation. Motors can be used to automatically set the angles and height.

Equipment can also be configured for right or left hand use, such as the position of controls, accessories, a rotating arm rest, or a tray.

A light can include settings such as for brightness and color. Different types of lights include examination lights and ambient lights. Tools such as handpieces may have settings such as for suction, rotational speed (such as for a drill), torque setting (such as for a dental implant torque wrench), and power setting (such as for an ultrasonic scaler). Other settings can be made for factors such as type and volume of ambient music, room temperature and shade or curtain positions. Motors and circuits can be used to adjust these settings.

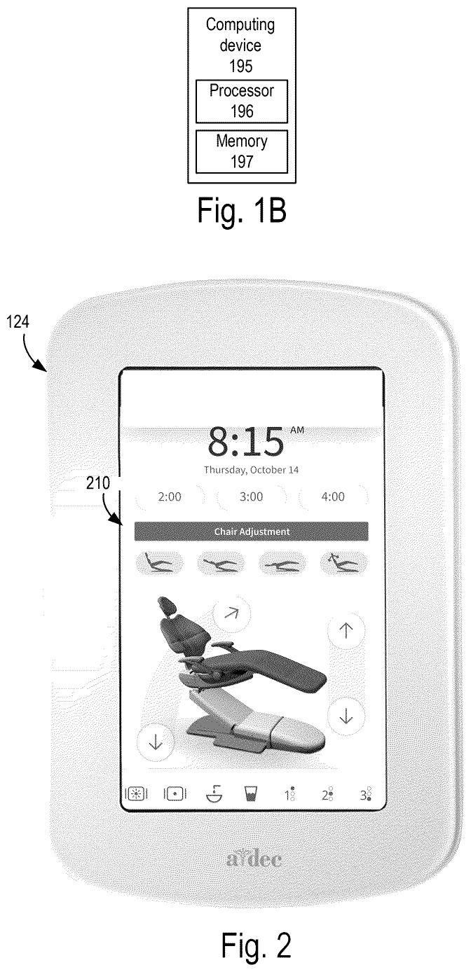

The operatory 120 further includes a user interface (UI) device 124, which can be associated with equipment, e.g., attached to or built into the equipment, or separate from the equipment, such as a standalone tablet or other screen. The UI device can allow a user to log in and control the equipment such as by turning it on or off. See FIG. 2. The UI device 124 can include user profiles and other software 125 in its memory, which is synchronized with software 151 at the server 150. The server can be a separate dedicated computing device or the server functionality can be incorporated into another computing device such as the personal computer (PC) 170. In another approach, the UI devices of an office are in a peer-to-peer local area network which does not have a central server.

The software 151 at the server 150 includes user profiles for the local office. For example, the user profiles can include, for each user, the preferred configuration settings for one or more types of equipment that are used at the local office 101. The software could include other software such as for providing automated configurations. For example, a second model of equipment may include configuration settings that are common with a first model of equipment, and an additional configuration setting that is not used in the first model. Once the common configuration settings are set for the first model, they can be automatically populated for the second model. The additional configuration setting can be automatically set at a default level which are common to all users, or to user-specific levels based, e.g., on learning the specific user's preferences.

For example, a first model of a dental chair may include configuration settings for an adjustable back rest angle but not an adjustable headrest angle, while a second model includes configuration settings for both an adjustable back rest angle and an adjustable headrest angle.

The automated configurations could be used to translate configuration settings from one model of equipment to another model of the equipment.

The automated configurations could be used to reconcile differences between different models of a same type of equipment, e.g., a delivery system, patient chair, handpiece or operatory light. For example, different models of lights may differ in their color and/or brightness settings. If a user has preference for a certain color and/or brightness setting which is not available on a particular model, the automated configurations can select the closest match to the desired setting. For example, if a first model of a light can be configured with color temperatures of 3000 K, 4000 K and 5000 K and a user has a preference for 4000 K, the 4000 K setting can be selected when the user uses the first model. If a second model of the light can be configured with color temperatures of 3800 K or 4800 K, when the user uses the second model, the 3800 K can be selected, as it is the closest match to the 4000 K.

In another example of the automated configurations, if one chair does not extend as low as a preferred setting, the backrest angle of the chair could be changed so that the patient is more reclined, with the goal of lowering the height of the head of the patient to the same level as would have been achieved with the chair at the preferred lowest position. This might be preferred by a clinician who is shorter in stature, for example.

The server 150 could include other software such as for providing usage metrics to indicate, e.g., an amount of time that a user has spent using a piece of equipment. This can be useful to track user efficiency and maintenance needs.

In another example, the time and intensity of usage of a tool or other equipment can be tracked. For example, the time of usage and the power setting of a dental scaler can be tracked. A dental scaler is a dental instrument that utilizes high-frequency vibrations to remove plaque, tartar, and stains from teeth. The power setting refers to the level of vibration intensity and can range from a minimum to a maximum.

The system 100 further includes an example of a portable UI device 160 such as a smart phone and a PC 170 such as might be used at the front desk or administration area of the office.

The server 190 with software 191 is in communication with the network cloud 110. The software 191 can include user profiles and other software for each of the local offices 101, 102 and 103. When the configuration settings are updated, e.g., set or changed, at one office 101, they can be communicated to the network cloud 180 to update the user profiles at the server 190. Other data can also be communicated and synchronized among the software 125, 151 and 191 such as the automated configurations and the usage metrics.

Generally, the user profiles can be synchronized within an office and between different offices. For example, when the server 190 receives updated profile data from one of the offices 101, it communicates it to the other offices 102 and 103 so that they are also synchronized. The synchronization can occur periodically at specified times, e.g., every few seconds, or based on an event such as when a profile is updated.

When a user logs into the UI device 124, it can communicate with the local server 150, which in turn communicates with the server 190, to ensure the UI device 124 has the current profile data for the user. The term “log in” can refer generally to the user identifying him or herself to the UI device. The log in can be a secure (such as where credentials are required) or non-secure process (such as where the user merely touches a button with their name). The log in can be an active or passive process. Moreover, the log in of a user to a single UI device in an operatory can be sufficient to implement the configuration settings for multiple types of equipment in the operatory. For example, when a user logs into the UI device 124, it can communicate with the local server 150, which in turn communicates with the server 190, to ensure that each of multiple UI devices in the office 101 have the current profile data for the user.

Accordingly, when a user travels between offices, the same configuration settings are available to setup the equipment as desired.

In one approach, a user profile is augmented over time as a user accesses additional pieces of equipment. For example, configuration settings may be added to a profile when a user accesses electric hand pieces in one operatory. Additional configuration settings may be added to the profile when the user accesses air powered hand pieces. Over time, new devices/types of equipment are added to build the profile so that many more possible combinations are included and the profile becomes more comprehensive.

In one approach, a pre-built user profile can be associated with a user before the user has built up his or her own profile. The pre-built profile can have default configuration settings. The pre-built profile can be assigned based on the user's role, e.g., student, dentist or hygienist. For example, the profile of a student dentist may limit the power setting of a tool to a lower level than for a credentialed dentist. As another example, the profile of a hygienist may not allow the user of certain equipment.

The pre-built profile can be based on physical characteristics of the user, such as their height, arm reach, degree of mobility and right-or left-handedness. For example, a shorter user may prefer a relatively lower chair height, or a user with reduced mobility may prefer a relatively higher chair height. A user who is more sensitive to glare may prefer a certain light setting for an examination light or a ceiling or other ambient operatory light. For example, 4000K-5500K (Neutral to slightly cool white) may be used to best balance accuracy with eye comfort, 5500K-6500K may be used for best color matching, and slightly lower, warmer, or neutral tones (4000K-5000K) may cause less glare-related fatigue. In some cases, a dimmer setting of a light can be configured based on a user preference. In some cases, a preference for a light diffuser can be configured.

In one approach, a default setting is replaced by a new setting made by the user such as via a UI device. Or the UI device can include a “save” button which can be selected by the user to save the current setting.

In another example, the preferences of the user profiles relate to dependent actions regarding the equipment, e.g., a second action that occurs based on a first action occurring. For example, a configuration setting can indicate whether an examination light is to automatically turn on when the patients is moved to a reclined position in the chair. A configuration setting can indicate whether a notification to the user is provided via a display and/or by an audible sound via a UI device. A configuration setting can indicate the preferred volume of an audible notification.

Configuration settings can indicate preferences in terms of an order in which the settings are implemented. For example, a user may prefer to configure the lights before configuring the chair.

Configuration settings for a piece of equipment can be based on a location of the equipment, e.g., a certain operatory or dental office, where the different locations are associated with different procedures to be performed. For example, one operatory may be intended for restorations and another operatory is intended for hygiene. A given dentist visits both of the operatories during their normal course of the day, but may want different chair settings, for instance, in the different operatories.

A profile can thus indicate different configuration settings for a piece of equipment based on a location of the equipment.

In another approach, the user enters information into a UI device to identify the type of procedure and the corresponding configuration settings are implemented.

In another approach, the type of procedure is identified from a scheduling system which indicates a certain patient is to undergo a certain procure at a certain day and time.

In another approach, a profile includes configuration settings based on a workflow or type of clinical scenario. For example, when a procedure involves a tooth that is susceptible to breaking, the configuration of equipment such as the position of the chair, or the power or speed of a hand tool, may be adjusted based on the procedure.

Generally, the configuration settings can be based on the type of procedure or workflow. Example procedures include: a) preventive and diagnostic procedures such as dental exams, digital X-rays (radiographs), and teeth cleaning, b) restorative procedures such as fillings, crowns, bridges, root canals (endodontics) and dentures, c) cosmetic procedures such as teeth whitening, veneers, and dental bonding, d) oral surgery and tooth replacement procedures such as dental implants, extractions, and bone grafting, e) orthodontics procedures such as including braces and clear aligners, f) periodontal treatment procedures such as scaling and root planing, and g) Temporomandibular Joint (TMJ) and Temporomandibular Muscle Disorders (TMD) treatments.

An example of adjusting the configuration settings based on the procedure is altering the dental chair position from upright to supine (fully reclined) when switching from a patient consultation to a restorative procedure. Other examples involving the dental chair are as follows. For maxillary (upper) arch procedures, the chair can be placed in a full supine position (nearly flat), while the headrest is adjusted to tilt the head back, allowing the dentist to look up into the mouth. For mandibular (lower) arch procedures, the chair can be kept in a more semi-reclined or upright position, with the patient's head positioned slightly forward to optimize access to the lower teeth. For impressions or consultation, the chair can be kept in a fully upright position for patient comfort and safety during entry/exit.

Examples involving dental handpieces can include adjusting the configuration settings to use a relatively high-speed and/or torque for cavity preparation or removing old restorations because they are efficient at cutting through enamel, or to use a relatively low-speed and/or torque for polishing, refining a preparation, or specialized endodontic/prosthodontic work, as they provide better control for delicate, detailed adjustments.

Examples involving ultrasonic scalers can include adjusting the configuration settings to use a relatively high power setting for heavy calculus removal and a relatively low power setting for subgingival scaling or root planing.

Examples involving a dental light can include adjusting the configuration settings to allow the light to shine up into the oral cavity from the neck/chin area for a maxillary procedure, and angling the light directly down into the mouth for a mandibular procedure.

Each of the configuration settings can be tailored to the preferences of a user and made portable across different pieces of equipment and locations. For example, preferences for a chair angle, handpiece speed, torque and/or power setting, and a light angle and/or brightness can be set based on a user profile and procedure, where these preferences are portable across different pieces of equipment.

In one approach, the user can select a current procedure on a UI device to implement the associated settings, then selects a next procedure to implement the associated settings, and so forth.

Note that the configuration settings can be implemented immediately when the user logs in to a piece of equipment or at a later time based on a further command of the user. Also, multiple configuration settings can be associated with a piece of equipment. For example, one set of configuration preferences can be associated with a chair when the patient is in an upright seated position and another set of configuration settings can be associated with the chair when the patient is in a reclined position.

The configuration settings can also involve maximum or minimum settings, e.g., for translational or angular/rotational movement of a piece of equipment. For example, a preference can be for a maximum brightness of an examination light, but the examination light is not necessarily set at that maximum level when the user logs in to the equipment. In another example, a preference can be for a minimum chair height, but the chair is not necessarily set at that minimum level when the user logs in to the equipment.

The UI devices may also allow a user to override the preferences for the maximum or minimum settings.

FIG. 1B depicts an example computing device 195, in accordance with various embodiments. The computing device can represent any of the devices in FIG. 1A including the UI device 124, the server 150, the PC 170 and the portable UI device 160. The computing device can include any combination of hardware or software which is configured to provide the features described herein. The computing device 195 includes a memory 197 configured to store instructions and a processor 196 configured to execute the instructions to provide the features described herein. The memory may be a tangible, non-transitory storage medium. One or more processors and one or more storage mediums may be used. The computing device may be used to perform computer-implemented methods to provide the features described herein.

FIG. 2 depicts an example implementation of the user interface (UI) device 124 of FIG. 1A, in accordance with various embodiments. The UI device may be associated with a patient chair, for example. The UI device includes a touchscreen 210 and includes buttons for adjusting the chair, such as the seat and back angle and the chair height.

In one approach, multiple UI devices are associated with an operatory, e.g., one for the dentist and one for the hygienist or other assistant. Different UI devices can be associated with different staff member roles, e.g., dentist, assistant, hygienist, technicians, and office manager. Different pieces of equipment and their configuration settings can be associated with different users based on their roles.

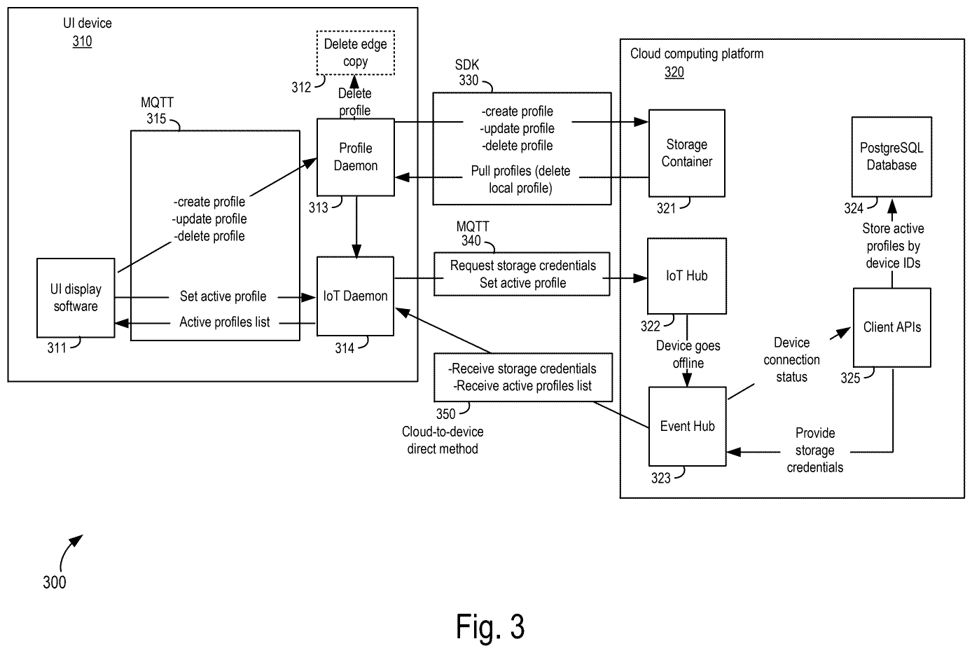

FIG. 3 depicts an example implementation of a system 300 consistent with FIGS. 1A, 1B, and 2, in accordance with various embodiments. The system includes a touch screen user interface (UI) device 310 and a cloud computing platform 320. The UI device can be a computing device at a dental operatory, and the cloud computing platform can be implemented on one or more servers, for example., which are local to or remote from the dental operatory.

One example of the UI device is the A-dec DS7 UI, available from A-dec Corp., Newberg, Oregon. The UI device includes UI display software 311 which interacts with background software components such as a delete edge copy function 312, a Profile Daemon 313 (a computer program that runs as a background process), and an Internet-of-Things (IoT) Daemon 314. A daemon is a computer program that runs continuously in the background. The UI display software transmits instructions to the Profile Daemon to create a profile, update a profile or delete a profile. These communications can be performed using Message Queuing Telemetry Transport (MQTT) 315, a messaging protocol that allows devices to communicate with each other and with the cloud. It can be used in the Internet of Things (IoT). For a deleted profile, the Profile Daemon transmits an instruction to the delete edge copy function 312.

The UI display software also transmits an instruction to the IoT Daemon 314 to set an active profile, e.g., a user profile, while the IoT Daemon transmits an active profiles list to the UI display software.

One example of the cloud computing platform 320 is the Microsoft Azure cloud computing platform. The Profile Daemon transmits to a Storage Container 321, such as the Azure storage container, to create a profile, update a profile or delete a profile. This communication can be performed using a Software Development Kit (SDK) 330 such as the Azure SDK, a collection of libraries that allow developers to easily interact with various Azure cloud services from their preferred programming language, such as Python, Java, C#, or JavaScript, enabling them to build applications on the Azure platform.

The Storage Container 321 transmits to the Profile Daemon 313 to pull (retrieve) profiles including deleting a local profile. This communication can be performed using the SDK 330.

The IoT Daemon 314 transmits to the IoT Hub 322, such as the Azure IoT hub, to request storage credentials and set an active profile. This communication can be performed using MQTT 340. The IoT Hub 322 transmits to an Event Hub 323 when the device goes offline. The IoT Hub 322 is a cloud-based service that allows devices to communicate with IoT applications. It can connect millions of devices and their backend systems.

The Event Hub 323 transmits to the IoT Daemon 314 to receive storage credentials and receive an active profiles list. This communication can be performed using a cloud-to-device direct method 350. This is a cloud platform feature that allows a cloud application to send immediate commands to a connected device and receive a response back, enabling real-time control and interaction with the device. It is a way to remotely execute functions on a device through a direct method call from the cloud.

The Event Hub 323 transmits a device connection status to Client Application Program Interfaces (APIs) 325. The Client APIs provide storage credentials to the Event Hub, and store active profiles by device ID in a PostgreSQL Database 324, an example of an open-source database system that supports Structured Query Language (SQL) and JavaScript Object Notation (JSON) querying.

The following provides a technical overview of the flow of profile between the UI device 310 and the cloud infrastructure, which is also referred to as the A-dec+cloud infrastructure in an example implementation.

UI display software 311 resides on a Linux operating system of the UI device 310, for example. In this flow, the software is responsible for:
a. Generating a new profile. It is the originating source of profile data.
b. Reading and interpreting the profile data for the current configuration of the system of connected products.
c. Facilitating the communication of these settings to the connected products.
d. Displaying this information graphically to the user.
e. Communicating via the local MQTT broker to the Profile Daemon 313 when a profile is created, updated, or deleted.
f. Communication via the local MQTT broker to the IoT Daemon 314 when the user switches the current active profile to another profile.

IoT Daemon—This software resides on the Linux operating system and is responsible for:
a. Requesting and receiving credentials that allow Profile Daemon 313 to securely store profile related data in the cloud. The storage can use the storage container 321, which in an example implementation is the Azure Storage Blob service as provided by the Azure Cloud. These are retrieved when the UI device is rebooted, and when the credentials expire (roughly 2 days).
b. Communicating those credentials to Profile Daemon 313 locally via MQTT 315.
c. Receiving a message via MQTT from the UI display software that the “active” profile of the UI display software has changed. This message is securely communicated to the Azure IoT Hub 322 (another Azure service) so that it can be processed by the cloud computing platform.
d. Receives an event driven message from the cloud computing platform via the Azure IoT Hub 322 about the total knowledge of which profiles are active across all UI devices that are registered to the same A-dec+ clinic/operatory account that the local UI device is registered to.

Profile Daemon 313—This software resides on the Linux operating system and is responsible for:
a. Receiving create, update, and delete messages from the UI display software via the local MQTT broker.
b. It will update the local “edge copy” of the profile located on the Linux file system that is regularly kept in sync with the fleet of devices related to the current A-dec+ clinic account.
c. Separately, it will update the remote copy of the profile in the Azure Storage Blob using the credentials provided by the IoT Daemon.
d. It will periodically, as told by the DS7 UI, be directed to pull the remote copies of the profiles from the Azure Storage Blob to be synced with the local edge copies.

Azure Storage Blob—This is a service is used to:
a. Remotely and securely store profile data in a container that is restricted to that A-dec+ clinic account.
b. Generates the secure credentials used to allow storage interaction via the Profile Daemon.

Azure Iot Hub—This is a service is used to:
a. Provide a secure connection between the UI device 310 via the IoT Daemon software and the broader A-dec+ cloud infrastructure via MQTT.
b. Allows the communication of targeted messages between the UI device and the A-dec+ cloud infrastructure. These messages from a UI device when routed through the IotHub are placed on to a queuing system to be processed, provided via Azure Event Hubs.

Azure Event Hub—This is a service is used to:
a. Provide a scalable working queue of device messages received by the IoT Hub.
b. Provide an interface, when an event is processed, for other cloud resources to read the data.
c. In this flow, the Event Hub is a queue used to process messages about the active profile for a given UI device.

Client API—This is a custom back end web application hosted within Azure Application Services and its purpose is to:
a. Read events from the EventHub about requests for Azure Storage Blob credentials. It communicates with the Azure Storage Blob (Container) to acquire credentials scoped to that particular A-dec+ clinic's remote storage of profile data, and via the Iot Hub, relays that information back to the UI device that requested it.
b. Read events from the EventHub about the active profile for a given UI device. This information is used to compile a complete list of active profiles across the fleet of UI devices for a given A-dec+ clinic account. This information is stored within the PostgreSQL database, and sent via the Iot Hub to the fleet of devices in order to keep synced between them which profiles are currently in use across the A-dec+ clinic account.

PostgreSQL Database—This is provided by the Azure Cloud services and is used to:
a. Store the relationship of a UI device being registered to a specific A-dec+ clinic account
b. Store the identifier of the active profile of a UI device. This is only storing the profile identifier and is not storing the content of the profile, in an example implementation.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope. Those with skill in the art will readily appreciate that embodiments may be implemented in a very wide variety of ways. This application is intended to cover any adaptations or variations of the embodiments discussed herein. Therefore, it is manifestly intended that embodiments be limited only by the claims and the equivalents thereof.

What is claimed is:

1. A system, comprising:
a plurality of user interface (UI) devices associated with a plurality of pieces of equipment in one or more dental offices; and
one or more servers coupled to the plurality of UI devices, wherein the one or more servers are to store user profile data indicating preferences for configuration settings of the plurality of pieces of equipment, and to synchronize the plurality of UI devices with the user profile data.

2. The system of claim 1, wherein the preferences are for configuration settings of the plurality of pieces of equipment in different operatories of a single dental office or of different dental offices.

3. The system of claim 1, wherein the one or more servers are configured to augment the user profile data over time as a user accesses additional pieces of equipment.

4. The system of claim 1, wherein the configuration settings indicate whether the equipment is configured for right or left hand use.

5. The system of claim 1, wherein the plurality of pieces of equipment includes at least one of a delivery system, a patient chair, a handpiece or an operatory light.

6. The system of claim 1, wherein the one or more servers are configured to reconcile differences between different models of a same type of equipment of the plurality of pieces of equipment.

7. The system of claim 1, wherein the user profiles include a pre-built profile based on a user's role.

8. The system of claim 1, wherein the user profiles include a pre-built profile based on a physical characteristic of a user.

9. The system of claim 1, wherein the user profiles relate to dependent actions regarding the plurality of pieces of equipment.

10. The system of claim 1, wherein the user profiles indicate preferences in terms of an order in which the configuration settings are implemented.

11. The system of claim 1, wherein the configuration settings include at least one of a suction, a rotational speed, a torque setting, or a power setting of a hand tool.

12. The system of claim 1, wherein the configuration settings include at least one of a maximum or minimum setting for at least one of a brightness of an examination light, a chair height, a chair backrest angle, or a level of vibration intensity for a dental scaler.

13. The system of claim 1, wherein each UI device of the plurality of UI devices is configured to:
receive instructions to create, update and delete user profiles at a profile daemon of the UI device;
communicate the instructions from the profile daemon to the one or more servers; and
pull user profiles from the one or more servers to the profile daemon.

14. The system of claim 1, wherein each UI device of the plurality of UI devices is configured to:
receive instructions at an Internet-of-Things (IoT) daemon of the UI device to set an active user profile; and
transmit, from the IoT daemon, a list of active user profiles.

15. A user interface (UI) device, comprising:
a memory configured to store instructions; and
one or more processors configured to execute the instructions to:
receive from user interface (UI) display software, at a profile daemon, instructions to create, update and delete user profiles;
communicate the instructions from the profile daemon to a cloud computing platform; and
pull user profiles from the cloud computing platform to the profile daemon.

16. The UI device of claim 15, wherein the one or more processors are configured to execute the instructions to:
receive from the UI display software, at an Internet-of-Things (IoT) daemon, instructions to set an active user profile; and
transmit, from the IoT daemon to the UI display software, a list of active user profiles.

17. The UI device of claim 16, wherein the one or more processors are configured to execute the instructions to:
transmit, from the IoT daemon to an IoT hub of the cloud computing platform, instructions to request storage credentials and to set an active user profile.

18. The UI device of claim 16, wherein the one or more processors are configured to execute the instructions to:
receive, at the IoT daemon, from an event hub of the cloud computing platform, storage credentials and a list of active user profiles.

19. One or more servers, comprising:
a memory configured to store instructions; and
one or more processors configured to execute the instructions to:
receive from a profile daemon of each user interface (UI) device of a plurality of UI devices, instructions to create, update and delete user profiles; and
transmit user profiles to the profile daemon of each UI device of the plurality of UI devices.

20. The one or more servers of claim 19, wherein the one or more processors are configured to execute the instructions to:
receive from an Internet-of-Things (IoT) daemon of each UI device of the plurality of UI devices, a request for storage credentials and a request to set an active user profile; and
transmit to the IoT daemon of each UI device of the plurality of UI devices, the requested storage credentials and a list of active user profiles.
